(19) United States
(12) Patent Application Publication
(10) Pub. No.: US 2015/0073692 A1
(43) Pub. Date: Mar. 12, 2015

(54) DRIVER FEEDBACK FOR FUEL EFFICIENCY

(71) Applicant: UT-Battelle, LLC, Oak Ridge, TN (US)

(72) Inventor: Andreas Malikopoulos, Knoxville, TN (US)

(73) Assignee: UT-BATTELLE, LLC, Oak Ridge, TN (US)

(21) Appl. No.: 14/323,875

(22) Filed: Jul. 3, 2014

Related U.S. Application Data
(60) Provisional application No. 61/877,216, filed on Sep. 12, 2013.
(60) Provisional application No. 61/877,446, filed on Sep. 13, 2013.

(51) Int. Cl. B60W 40/10

(52) U.S. Cl. CPC B60W 40/10
USPC 701/123

(57) ABSTRACT

Systems, methods, and computer-readable media for providing feedback to a driver are provided herein. Vehicle speed or acceleration data can be received for a location on a route. A current acceleration value for the location is derived using the received vehicle speed or acceleration data. A preferred acceleration value for the location is determined based on a preferred speed or acceleration profile that is specific to the route. An indication of a correspondence between the preferred acceleration value for the location and the current acceleration value for the location is then provided. The indication can be, for example, a graphic comparing the preferred and current acceleration values. Based on the indication, a driver can adjust acceleration to conform to the preferred acceleration value.

### CROSS REFERENCE TO RELATED APPLICATIONS

This application claims the benefit of U.S. Provisional Application No. 61/877,216, filed on Sep. 12, 2013 and titled “DRIVER FEEDBACK FOR FUEL EFFICIENCY,” and U.S. Provisional Application No. 61/877,446, filed on Sep. 13, 2013 and titled “DRIVER FEEDBACK FOR FUEL EFFICIENCY,” both of which are incorporated herein by reference in their entirety.

### ACKNOWLEDGMENT OF GOVERNMENT SUPPORT

This invention was made with government support under Contract No. DE-AC05-00OR22725 awarded by the U.S. Department of Energy. The government has certain rights in the invention.

### BACKGROUND

Modern vehicles have sophisticated electronic control units that control engine operation to balance fuel economy, emissions, and power. These control units are designed for specific driving conditions (e.g., different speed profiles for highway and city driving). However, individual driving styles are different and rarely match the specific driving conditions for which the units were designed. As a consequence, drivers often complain that new vehicles do not achieve the gas mileage estimates displayed on window stickers.

Fuel efficiency can be increased by adopting various general driving behaviors, including: moderating speed; accelerating evenly and smoothly; driving slowly and continuously in stop-and-go traffic; maintaining a constant speed; and avoiding intense acceleration and deceleration. Conventional driving behavior modification tools typically focus on one or more of these general driving behaviors and can provide a driver with generalized feedback. The fuel economy improvement achieved using these conventional tools, however, is somewhat limited.

### SUMMARY

Examples described herein relate to computer-implemented approaches to increasing vehicle fuel efficiency. Using the systems, methods, and computer media described herein, route-specific driving feedback can be provided to a driver, allowing the driver to modify driving behavior to increase fuel efficiency while driving along a given route. Such feedback can be provided for the duration of the route. Driving feedback can be an indication of a correspondence between a current acceleration value and a preferred acceleration value for each of many locations on the route. For example, a graphic can be displayed that compares current and preferred acceleration values, allowing the driver to adjust acceleration to conform to the preferred acceleration value. In particular, the described approaches can improve fuel efficiency when a driver repeatedly travels along the same route, for example, as part of a commute to work or school, as part of a bus route, or as part of a fixed delivery route.

A current acceleration value for a location can be derived using vehicle speed or acceleration data (e.g., vehicle speed or acceleration data received in real-time). A preferred acceleration value for the location can be determined based on a preferred speed or acceleration profile that is specific to the route (e.g., a predetermined preferred route-specific profile). The preferred speed or acceleration profile provides greater fuel efficiency over the route compared to an observed speed or acceleration profile, which is based on one or more previous trips along the route. The preferred profile can be based at least in part on the observed speed or acceleration profile.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages of the claimed subject matter will become more apparent from the following detailed description, which proceeds with reference to the accompanying figures.

### BRIEF DESCRIPTION OF THE DRAWINGS

FIG. 1 is a flowchart of an example method for increasing vehicle fuel efficiency.

FIG. 2 is a partial perspective view of an example vehicle interior implementing an example driver feedback system.

FIGS. 3A-3D are example graphics showing a correspondence between current and preferred acceleration values.

FIG. 4 is a flowchart of an example method for increasing vehicle fuel efficiency in which an indication of correspondence between current and preferred acceleration values is provided for multiple locations on a route.

FIG. 5 is a flowchart of an example method for increasing vehicle fuel efficiency in which an alternative preferred acceleration value is determined if the current vehicle speed is below a threshold.

FIG. 6 is a block diagram of an example preferred speed or acceleration profile determination system.

FIG. 7 is a flowchart of an example method for increasing vehicle fuel efficiency in which a preferred speed or acceleration profile is determined.

FIG. 8 is a plot showing an original vehicle speed profile and an optimized vehicle speed profile.

FIG. 9 is a diagram of an example mobile device with which some described examples can be implemented.

FIG. 10 is a diagram illustrating a generalized example of a suitable implementation environment for any of the disclosed examples.

### DETAILED DESCRIPTION

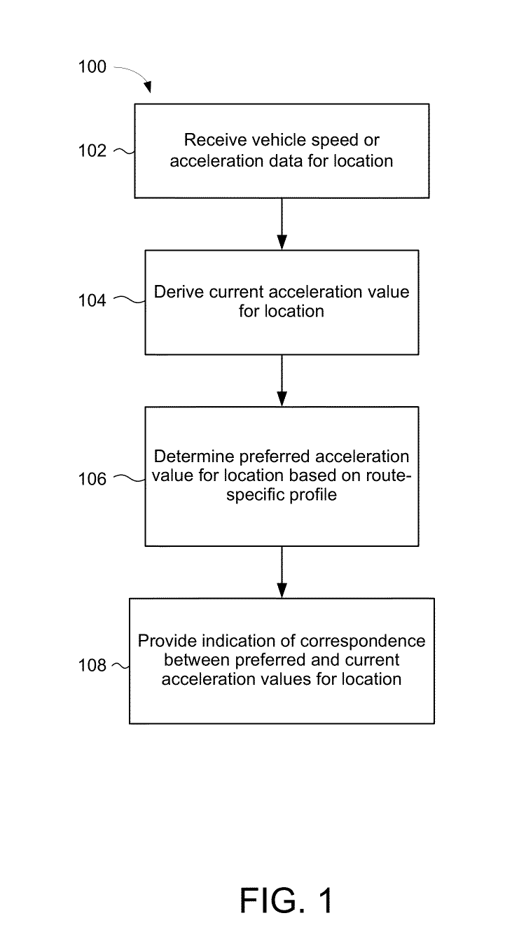

Examples described herein provide systems, methods, and computer-readable media for increasing vehicle fuel efficiency. Route-specific driving feedback can be provided while a vehicle is traveling on a route. The driving feedback allows a driver to modify driving behavior in a route-specific manner that increases vehicle fuel efficiency. Examples are described in detail below with reference to FIGS. 1-10.

FIG. 1 illustrates an example method 100 for increasing vehicle fuel efficiency. The method 100 can be performed in a real-time feedback system as a driver travels along a route for which a preferred route-specific profile is available.

In process block 102, vehicle speed or acceleration data is received for a location on a route. For example, real-time location data indicating the location is received using a global positioning system (GPS) receiver, while real-time vehicle speed or acceleration data is received from a vehicle's onboard computer. The location data and vehicle speed or acceleration data is “real-time” data in that it is received during operation of the vehicle, even if the “real-time” data is not exactly tied to the present time. Alternatively, location data for the location can be received from triangulation or other interpolation using signals from multiple cellular radio towers or from another source. Alternatively, the vehicle speed or acceleration data can be received from the GPS receiver or from another source.

A current acceleration value for the location is derived in process block 104 using the received vehicle speed or acceleration data. GPS data, for example, can indicate both a current location and a current speed, and a current acceleration value can be calculated as the change in speed divided by the distance between two locations, yielding an average acceleration value between the two locations. Alternatively, the current acceleration value is derived more directly, for example, from acceleration data received from the vehicle's onboard computer, yielding an acceleration value closer to the instantaneous acceleration value.

In process block 106, a preferred acceleration value for the location is determined based on a preferred speed or acceleration profile that is specific to the route. In some examples, the preferred speed or acceleration profile comprises a plurality of locations and preferred speed or acceleration value pairs for the respective locations. For an identified location along the route, a preferred speed or acceleration value can be retrieved and used to determine the preferred acceleration value for the location. In such cases, if a preferred acceleration value is retrieved, this value can be used directly as the determined preferred acceleration value, and if a preferred speed is retrieved, a preferred acceleration value can be calculated. Alternatively, if an identified location does not exactly match a location directly represented in the preferred route-specific profile, a preferred speed or acceleration value for a closest location in the preferred route-specific profile can be used, so long as the closest location is within a threshold of distance from the identified location. Or, an interpolated value for the identified location can be computed between two preferred speed or acceleration values for two locations directly represented in the preferred route-specific profile, depending on relative distances between the identified location and two locations.

The preferred route-specific profile is based on a predetermined route-specific profile. Example approaches to generating route-specific predetermined preferred speed or acceleration profiles from observed speed or acceleration profiles are discussed in detail below. When used in the real-time feedback system, the predetermined route-specific profile can be directly used as the preferred route-specific profile. Or, the predetermined route-specific profile can be adjusted in the real-time feedback system (e.g., scaled to account for changes in conditions, truncated to part of the route) to create the preferred route-specific profile.

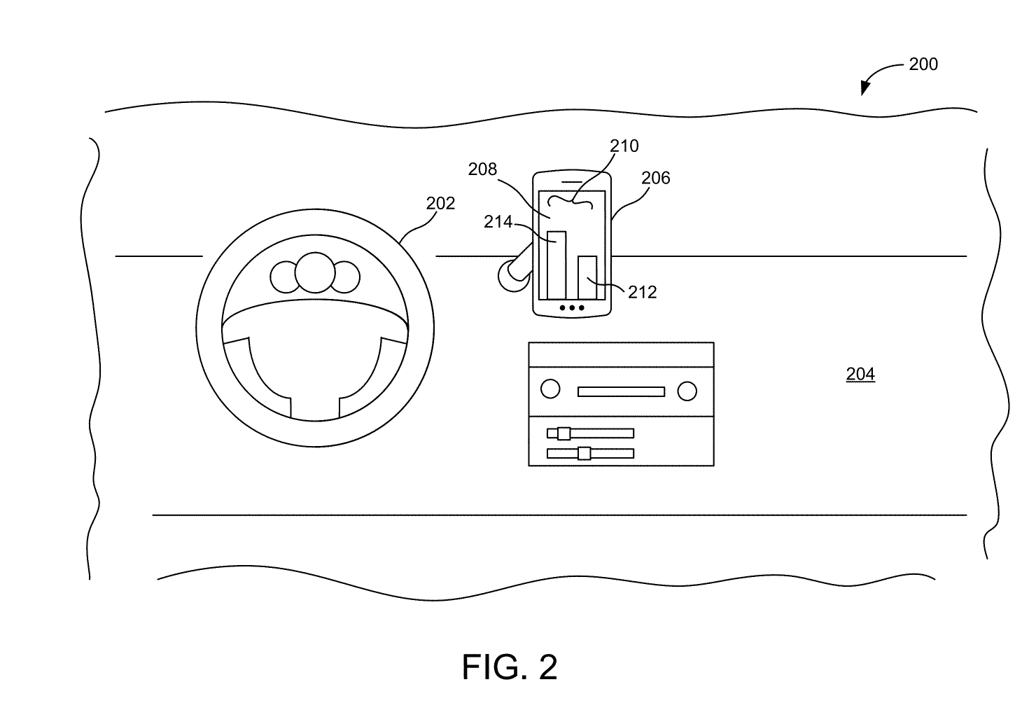

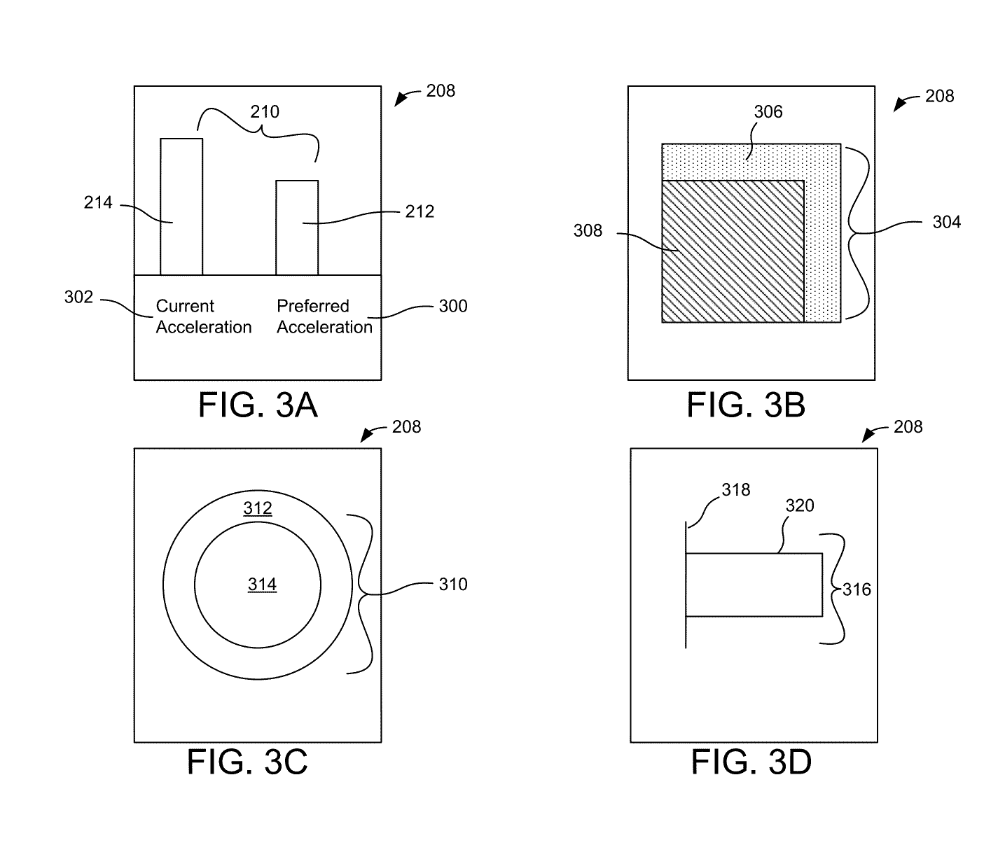

An indication of a correspondence between the preferred acceleration value for the location and the current acceleration value for the location is provided in process block 108. In some examples, providing the indication of correspondence in process block 108 includes displaying a graphic. Examples of graphics are illustrated in FIGS. 2-3D. In other examples, the indication is a tone, and the pitch of the tone is varied depending on the correspondence between the current acceleration value and the preferred acceleration value. For example, as the difference between the current acceleration value and the preferred acceleration value increases, the tone can increase in volume or pitch, or the tone can be played more frequently (i.e., repeated more quickly). Alternatively, the indication of correspondence between the current acceleration value and the preferred acceleration value is provided through tactile feedback (e.g., vibration) or in some other way.

FIG. 2 shows a portion of a vehicle's interior 200 with a real-time feedback system. The vehicle can be an automobile, bus, delivery truck, long-haul truck, train, motorcycle or other type of vehicle. Interior 200 includes a steering wheel 202 and a dashboard 204. A mobile device 206 having a display 208 is mounted on dashboard 204. Mobile device 206 can be, for example, a smart phone, tablet, laptop, netbook, or other computing device. Mobile device 206 includes an “app” or application, or other software, that implements the real-time feedback system. Mobile device 206 stores one or more preferred route-specific profiles for one or more routes. In operation as a real-time feedback system, mobile device 206 receives location data as well as vehicle speed or acceleration data (e.g., from a GPS receiver or onboard computer). Alternatively, a computing device other than a mobile device 206 (e.g., a GPS device or onboard computing device) can assume the role of the mobile device 206 in the real-time feedback system. The real-time feedback system can also be implemented by the vehicle's original equipment manufacturer (OEM). For example, the onboard computer can be configured to receive location and vehicle and/or speed data, and a dashboard display can assume the role of display 208.

In FIG. 2, mobile device 206 is displaying a graphic 210 that illustrates a comparison between a representation 212 of the preferred acceleration value and a representation 214 of the current acceleration value. In graphic 210, the representation 212 of the preferred acceleration value and the representation 214 of the current acceleration value are vertical bars, where the size of the bars is proportional to the corresponding acceleration value. Mobile device 206 can be mounted in such a way that a driver of the vehicle can view graphic 210 while driving and adjust driving behavior accordingly. For example, if graphic 210 shows that the current acceleration value is greater than the preferred acceleration value, the driver can ease off of the accelerator. Similarly, if graphic 210 shows that the current acceleration value is less than the preferred acceleration value, the driver can increase the force applied to the accelerator. Display of graphic 210 on mobile device 206 can be controlled by the “app” or application on mobile device 206, or controlled by other software on mobile device 206.

Mobile device 206 can store a plurality of preferred profiles corresponding to respective routes and can present a user interface that allows a user to select a route for which a preferred profile is available. For example, a user about to begin a commute to work can access the “app” and select “Commute” or “Work,” which corresponds to a stored preferred profile for the user's commute to work. Various other user interfaces are also contemplated that, for example, allow for starting and stopping display of graphic 210, switching or altering graphics, and switching among graphics, sounds, tactile feedback, and other type of indications.

Graphic 210 can take a variety of other forms. FIG. 3A is a close-up illustration of graphic 210, and FIGS. 3B-3D illustrate alternative graphics. FIG. 3A shows display 208 and graphic 210. Below representation 212 of the preferred acceleration value is a label 300 that reads “Preferred Acceleration,” and below representation 214 of the current acceleration value is a label 302 that reads “Current Acceleration.” Other labels, such as “Target Acceleration,” “Target,” or “Desired Acceleration” (for “Preferred Acceleration”) and “Instantaneous Acceleration” or “Actual Acceleration” (for “Current Acceleration”) can also be used. Colors, bolding, size, and other ways of distinguishing between current and preferred acceleration are also contemplated and can be used instead of or in addition to text descriptions. For example, representation 212 of the preferred acceleration value can be displayed in a first color (e.g., green), and representation 214 of the current acceleration value can be displayed in a second color (e.g., red).

FIG. 3B shows display 208 and a graphic 304. Graphic 304 includes a first shape 306 representing the preferred acceleration value and a second shape 308 representing the current acceleration value. The sizes of first shape 306 and second shape 308 can be proportional to the respective magnitudes of current and preferred acceleration. When the size of first shape 306 and second shape 308 are equal, current acceleration is equal to preferred acceleration. A driver viewing graphic 304 can understand from graphic 304 that current acceleration, represented by second shape 308, is less than preferred acceleration, represented by first shape 306, and can increase acceleration. In some examples, first shape 306 representing preferred acceleration remains at a constant size even if the preferred acceleration value has changed, and the current acceleration value is shown with the second shape 308 as a proportion of the preferred acceleration value. In such examples, the driver's visual acceleration target (preferred acceleration) remains easy to focus on, and only second shape 308 representing current acceleration changes from location to location.

The first shape 306 can have a first color (e.g., green) while the second shape 308 has a second color (e.g., red) different than the first color. Or, the second shape 308 can have a color that changes depending on how the current acceleration value compares to the preferred acceleration value. For example, suppose the first shape 306 has a first color (e.g., gold). If the current acceleration value is less than the preferred acceleration value, the second shape 308 can have a second color (e.g., green) to indicate acceleration should increase, and if the current acceleration value is more than the preferred acceleration value, the second shape can have a third color (e.g., red) to indicate acceleration should decrease. If the current acceleration value is within a threshold of closeness to the preferred acceleration value, the second shape 308 can have the first color (e.g., gold) to match the first shape 306. The threshold can help avoid “flickering” between the second and third colors when the current acceleration value is close to the preferred acceleration value.

In FIG. 3B, first shape 306 and second shape 308 are squares, but other shapes such as rectangles, triangles, circles, trapezoids, etc., are also contemplated. FIG. 3C illustrates an example in which a graphic 310 includes two shapes that are circles—first circle 312 represents preferred acceleration, and second circle 314 represents current acceleration. Similarly to FIG. 3B, when the size of first circle 312 and second circle 314 are equal, current acceleration is equal to preferred acceleration. Sizes and colors of the first circle 312 and second circle 314 can be set as described with reference to the shapes of FIG. 3B.

Graphics 210, 304, and 310 in FIGS. 3A-3C compare current vehicle acceleration and preferred vehicle acceleration for a location on the route and therefore provide a real-time (near instantaneous or incremental) evaluation of vehicle performance. Graphics 210, 304, and 310 can be updated to reflect new values of current acceleration and/or preferred acceleration for successive locations as a vehicle progresses along a route. For example, the preferred acceleration in graphics 210, 304, and 310 can repeatedly update after a distance or time interval. In one example, a distance interval is selected that is greater than a GPS position error associated with a GPS receiver. Current acceleration may change from one location to the next based on the driver's response to graphics 210, 304, and 310, terrain features, traffic or weather conditions, or other factors, causing an update to the indication of current acceleration in graphics 210, 304, and 310. The preferred acceleration may also be different for a new location. The result of incrementally updating graphic 304 (or 210 or 310), in one example, is that the size of first shape 306 (or 212 or 312) that represents preferred acceleration remains constant while the size of second shape 308 (or 214 or 314) that represents current acceleration changes incrementally, allowing a driver to continue to adjust the current acceleration to conform to the preferred acceleration each time graphic 304 (or 210 or 310) updates, thereby increasing fuel efficiency for the route. In other examples, the size of both first shape 306 (or 212 or 312) and second shape 308 (or 214 or 314) are adjusted incrementally.

FIG. 3D illustrates another example graphic 316. In graphic 316, a line 318 represents the preferred acceleration value. A bar 320 represents the current acceleration value. The extent of bar 320 represents the difference between preferred and current acceleration values. In one example, bar 320 is not visible or is minimally visible when the preferred acceleration value equals the current acceleration value. Bar 320 extends to the right when the current acceleration value is greater than the preferred acceleration value and extends to the left when the current acceleration value is less than the preferred acceleration value.

Alternatively, a graphic can illustrate the correspondence between preferred and current acceleration values using a single shape. For example, the color of the shape can change depending on difference between the current acceleration value and preferred acceleration value. If the current acceleration value is less than the preferred acceleration value, the shape can have a first color (e.g., green) to indicate acceleration should increase, and if the current acceleration value is more than the preferred acceleration value, the shape can have another color (e.g., red) to indicate acceleration should decrease. If the current acceleration value is within a threshold of closeness to the preferred acceleration value, the shape 308 can have a third color (e.g., gold). The threshold can help avoid “flickering” between the first two colors when the current acceleration value is close to the preferred acceleration value. The size of the shape can be constant, or it can change depending on acceleration or speed to give visual feedback that the system is operational.

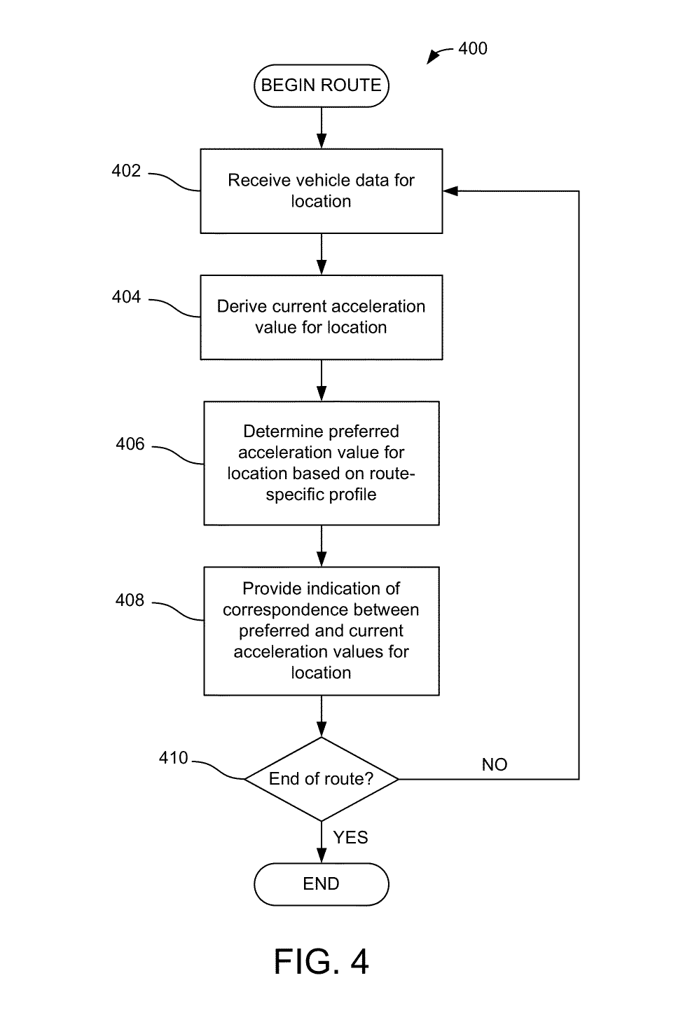

FIG. 4 is a flow chart of an example method 400 of increasing vehicle fuel efficiency in which current and preferred acceleration values are determined for successive locations on a route, from the beginning of the route until the end of the route. The method 400 can be performed in a real-time feedback system as a driver travels along the route.

In process block 402, vehicle speed or acceleration data is received for a location on a route. For example, the vehicle speed or acceleration data is received as described with reference to process block 102 of the method 100 of FIG. 1.

A current acceleration value for the location is derived in process block 404 using the received vehicle speed or acceleration data. For example, the current acceleration value is derived as described with reference to process block 104 of the method 100 of FIG. 1.

In process block 406, a preferred acceleration value for the location is determined based on a preferred speed or acceleration profile that is specific to the route. For example, the preferred acceleration value is determined as described with reference to process block 106 of the method 100 of FIG. 1.

An indication of a correspondence between the preferred acceleration value for the location and the current acceleration value for the location is provided in process block 408. For example, the indication is provided as described with reference to process block 108 of the method 100 of FIG. 1.

In decision box 410, it is determined if the current location is at or close to the end of the route. A threshold distance from the end of the route can be set, after which method 400 terminates. In one example, the threshold is one or two distance intervals from the end of the route. If it is determined in decision block 410 that the end of the route has been reached, the method 400 ends. If the end of the route has not been reached, the method 400 continues with process block 402 in which vehicle data is received for another location along the route. In this way, the indication of correspondence between the preferred and current acceleration values is periodically updated as the driver proceeds along the route. According to the method 400, the current acceleration value and preferred acceleration value can be updated at different rates by the real-time feedback system. For example, the current acceleration value can be updated based upon vehicle speed and/or acceleration data at a first rate (e.g., every 0.5 seconds), while the preferred acceleration value is updated based upon location data at a second rate (e.g., every 5 seconds or when locations change in the preferred route-specific profile).

In some implementations, the real-time feedback system updates the display only upon the satisfaction of other conditions. For example, the display is updated when the accelerator is pressed, as described above, but the display is blank if the accelerator is not pressed.

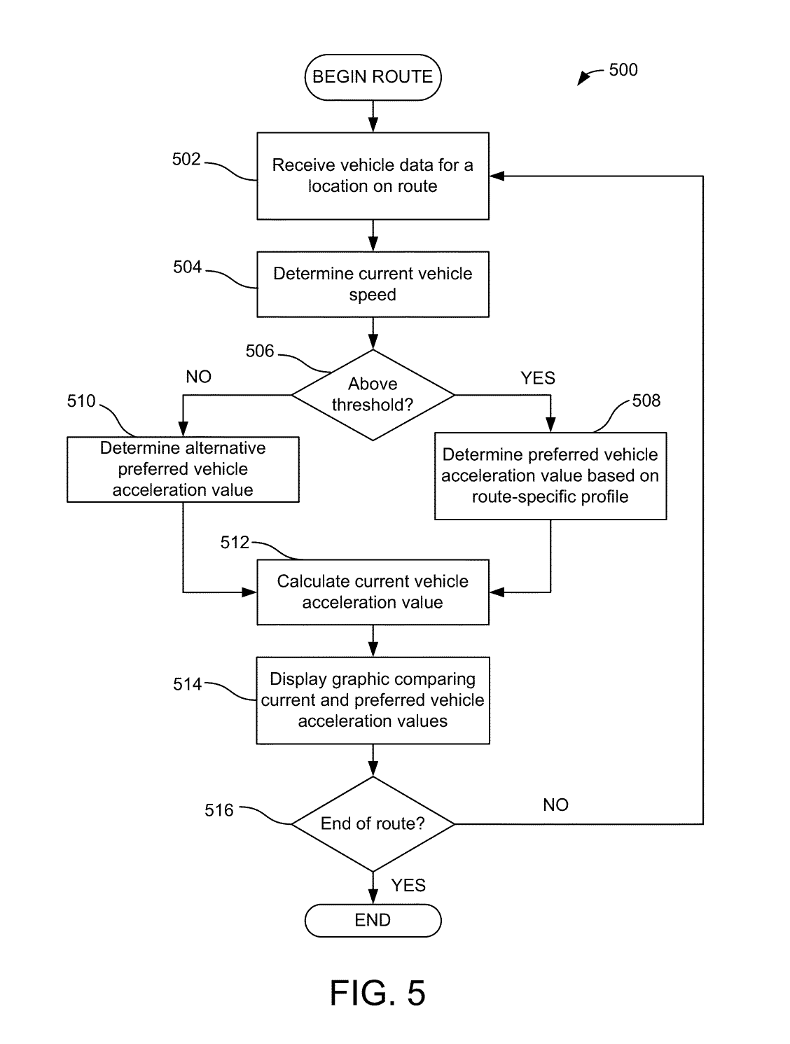

FIG. 5 illustrates a method 500 in which an alternative preferred acceleration value is determined if the current vehicle speed is below a threshold. The method 500 can be performed in a real-time feedback system as a driver travels along a route for which a preferred route-specific profile is available.

In process block 502, vehicle data are received for a vehicle at the location on the route. For example, the data are received as described with reference to process block 102 of the method 100 of FIG. 1.

A current vehicle speed is determined based on the received speed data in process block 504. GPS data, for example, can indicate the current speed. Alternatively, the current vehicle speed is determined more directly, for example, from speed data received from the vehicle's onboard computer.

In decision block 506, it is determined if the current vehicle speed is greater than a threshold. For example, the threshold can be an absolute speed value such as 10 miles per hour, or the threshold can be an extent of deviation from a vehicle speed expected at the location according to the route-specific profile.

If the current speed is greater than (or greater than or equal to) the threshold, a preferred vehicle acceleration value for the location is determined in process block 508, where the preferred vehicle acceleration value is based on a preferred speed or acceleration profile for the route. For example, the preferred vehicle acceleration value is determined as described with reference to process block 106 of the method 100 of FIG. 1. On the other hand, if the current speed is not greater than (or is less than) the threshold, an alternative preferred vehicle acceleration value is determined in process block 510. The alternative preferred vehicle acceleration value can be used, for example, while a vehicle is accelerating from a stop or experiencing traffic congestion, and the threshold can serve as a signal of such conditions. In either case, an observed speed or acceleration profile upon which the preferred speed or acceleration profile is based may not account for the stop or the congested traffic. The preferred speed or acceleration profile may therefore include a preferred acceleration value for the location that is not desirable given the current conditions. The alternative preferred vehicle acceleration value can be a fixed acceleration value that allows a driver to accelerate to regain a desired vehicle speed when exiting behavior-restricting conditions such as a stop or congested traffic. In some examples, the alternative preferred vehicle acceleration value comprises one of a tiered series of fixed values that can depend upon how far below the threshold the current vehicle speed is.

In process block 512, a current vehicle acceleration value is calculated for the location using the received speed and location data. For example, the current vehicle acceleration value is calculated as described with reference to process block 104 of the method 100 of FIG. 1.

A graphic comparing the current vehicle acceleration value to either the preferred vehicle acceleration value or the alternative preferred vehicle acceleration value is displayed in process block 514. For example, the graphic uses one of the approaches illustrated in FIGS. 3A-3D. A driver can use the information presented in the graphic to modify current vehicle acceleration to conform to the preferred or alternative preferred vehicle acceleration value. Alternatively, another indication of correspondence between the current acceleration value and preferred (or alternative preferred) acceleration value is provided.

In process block 516, it is determined if the end of the route has been reached. If so, method 500 ends. If the end of the route has not been reached, method 500 proceeds back to process block 502, where vehicle data are received for another location on the route. Method 500 proceeds accordingly until the end of the route has been reached. For example, the iteration of the method 500 is managed as described with reference to process block 410 of the method 400 of FIG. 4.

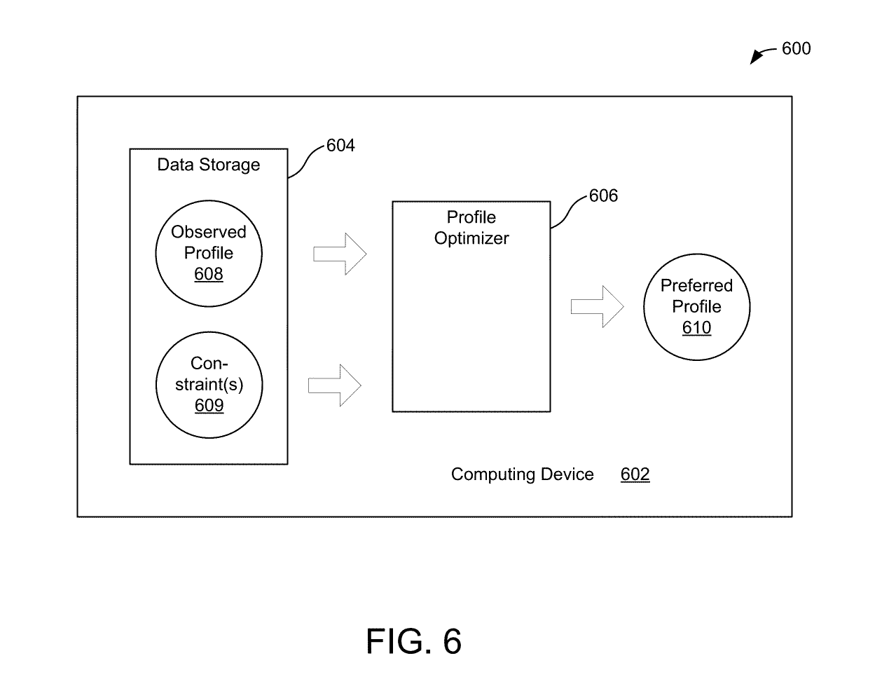

As discussed above with respect to method 100 of FIG. 1, method 400 of FIG. 4, and method 500 of FIG. 5, the preferred acceleration value for a location is determined based on a preferred speed or acceleration profile that is specific to the route. FIG. 6 illustrates a system 600 for determining the preferred speed or acceleration profile for a route.

System 600 is implemented on a computing device 602. Computing device 602 can be a server computer, client computer, mobile device, or other computing device. Computing device 602 includes software for a profile optimizer 606. Computing device 602 also includes data storage 604 storing one or more constraints 609 on the profile optimization process as well as data for an observed profile 608. For the sake of simplicity, computer hardware components such as processors, memory and user input devices are not shown. As used herein, the term “optimiz*” (including variations such as optimizing and optimizer) refers to improving and does not imply that an optimized profile is the “best” or “optimum” profile.

Profile optimizer 606 receives data for the observed speed or acceleration profile 608 and the one or more constraints 609. Profile optimizer 606 generates a preferred speed or acceleration profile 610, subject to the one or more constraints 609. As discussed above, the preferred speed or acceleration profile provides greater fuel efficiency compared to the observed speed or acceleration profile.

Observed speed or acceleration profile 608 can be determined using data obtained from a vehicle's computer as the vehicle travels along a route one or more times. The observed profile 608 can include speed and/or acceleration values for a plurality of locations on the route, as well as information about fuel efficiency. Preferred speed or acceleration profile 610 can be determined by smoothing observed speed or acceleration profile 608. Observed speed or acceleration profile 608 can include abrupt transitions in speed or acceleration, and smoothing these abrupt transitions into more gradual transitions can increase fuel efficiency. Smoothing can be performed using one or more algorithms. A variety of algorithms are possible for optimizing observed profile 608 to generate preferred profile 610. Example algorithms are discussed in detail below.

Algorithms for optimizing observed profile 608 can also consider the one or more constraints 609, which may be defined by a user or have default values. These constraints can include: (a) an acceptable difference in speed compared to the observed vehicle speed or acceleration profile and (b) an acceptable additional route completion time compared to duration of the observed vehicle speed or acceleration profile. For example, a user may value fuel efficiency but may also be concerned with maintaining a speed similar to other traffic for safety reasons or may be concerned with getting to work in a reasonable amount of time. By specifying an acceptable difference in speed compared to the observed vehicle speed or acceleration profile, for example, x miles or kilometers per hour (where x is a number greater than zero), the preferred speed or acceleration profile can be generated such that the preferred acceleration value at each location (or on average) keeps the vehicle within x miles (or kilometers) per hour of the observed profile. The value of x depends on implementation and can be, for example, 5. Similarly, by specifying an acceptable additional route completion time, for example y minutes or y percent (where y is a number greater than zero), a user can ensure that the preferred speed or acceleration profile results in the route being completed no more than an acceptable amount of time later than the route was completed using the observed vehicle speed or acceleration profile. The user constraints allow a user to have some input in the optimization process.

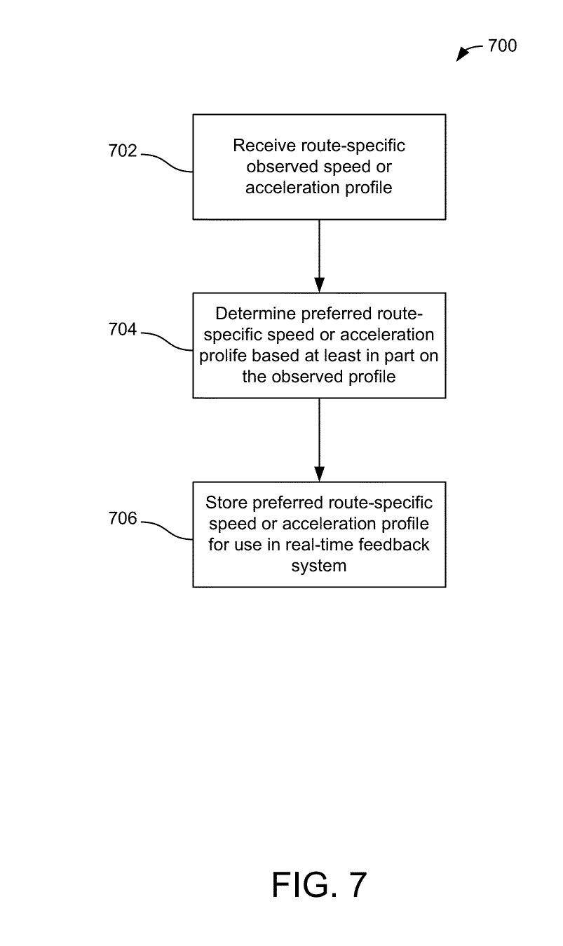

FIG. 7 illustrates a method 700 for increasing vehicle fuel efficiency in which a preferred speed or acceleration profile is determined. The method 700 can be performed in a computing device with a profile optimizer, as described with reference to FIG. 6.

In process block 702, an observed speed or acceleration profile that is specific to a route is received. An observed vehicle speed or acceleration profile can be determined by obtaining data from a vehicle's computer for one or more trips along a route, and the observed speed or acceleration profile can include speed and/or acceleration for a plurality of locations on the route. The data for the observed speed or acceleration profile can be collected from a vehicle's onboard computer, for example, using after-market software that retrieves the data from the onboard computer and stores the data on a USB device or other storage device. The data for the observed speed or acceleration profile can then be transferred to the computing device with the profile optimizer.

In process block 704, a preferred speed or acceleration profile that is specific to the route is determined based at least in part on the observed speed or acceleration profile. The preferred speed or acceleration profile can also depend on one or more user constraints. In general, the constraint(s) specify a tradeoff between delay and fuel efficiency. The preferred speed or acceleration profile includes speed or acceleration values for a plurality of locations on the route and provides greater fuel efficiency over the route compared to the observed speed or acceleration profile. Example algorithms for determining the preferred speed or acceleration profile are detailed below. Alternatively, other algorithms are used to determine the preferred speed or acceleration profile.

In process block 706, the preferred speed or acceleration profile is stored for use in a real-time feedback system. For example, the preferred speed or acceleration profile is stored at the computing device that includes a profile optimizer. Or, the preferred speed or acceleration profile is stored in a mobile computing device that itself provides the real-time feedback system.

### Example Algorithms for Generating Preferred Profiles

Certain driving factors under transient engine operating conditions are characterized by high fuel consumption. A set of polynomial metamodels can be constructed that explicitly formulates the relationship between fuel consumption and the identified driving factors. Optimization can then be used to generate a preferred speed or acceleration profile based on an observed profile and, in some examples, a driver's needs and preferences. The preferred profile can be used in a driver feedback system that can provide, for example, visual instructions to the driver to alter his/her driving behavior.

Engines are streamlined syntheses of complex physical processes in a convoluted, dynamic system. They are operated with reference to engine operating points; that is, engine torque and speed, and the values of various engine controllable variables. At each operating point, these values highly influence various engine performance criteria (e.g., fuel economy, emissions, and power). This influence becomes more important at engine operating point transitions, which may be dependent on a driver's driving style. To evaluate the impact of a driving style on fuel economy through simulation, standard dynamometer driving schedules (DDSs) (or simply driving cycles) can be used (i.e., vehicle speed profiles established by the U.S. Environmental Protection Agency (EPA) for testing and measuring fuel economy and emissions). These driving cycles are representative of typical urban and highway commutes. They essentially represent different ways in which a particular vehicle's speed profile changes depending on driving style of a driver. If driving factors can be used to explain the fuel economy variations among different driving cycles, then these same factors can be used to reflect the impact of different driving styles.

Transient operation typically constitutes the largest segment of engine operation over a driving cycle, compared to steady-state operation. Fuel consumption and emissions during transient operation are extremely complicated, vary significantly with each particular driving cycle, and are highly dependent upon engine calibration. State-of-the-art engine calibration methods generate a static correlation between the values of engine variables and corresponding steady-state operating points. This correlation is incorporated into the electronic control unit (ECU) of the engine to control engine operation. While the engine is running, these correlations are being interpolated to provide values of engine variables for each operating point.

Generally, it is preferable to operate an engine over steady-state operating points (e.g., highway driving) that are well optimized through the engine calibration and to avoid transient operation (e.g., stop-and-go driving, rapid acceleration). Furthermore, eliminating near-idle engine operation directly enhances fuel economy—at idle, the efficiency is zero because no usable work is being drawn from the engine. Consequently, two factors, formally defined below, have a major impact on engine operation and thus on fuel economy. These are (a) the stop factor and (b) the coefficient of power demand.

The stop factor is defined as the amount of time during a driving cycle that the vehicle is stopped (i.e., the cumulative duration that the vehicle's velocity is zero divided by the total duration of the driving cycle). This factor provides a convenient indication of idle engine operation over a driving cycle. When a vehicle is stopped during a drive cycle, the engine is idling. In this situation, fuel is consumed but the distance traveled is zero, so the fuel economy is reduced to 0 miles per gallon (MPG). There is a monotonic increasing correlation between the stop factor and fuel consumption: as the stop factor increases, fuel consumption also increases.

The second driving factor considered here is the coefficient of power demand. It provides an indication of the transient engine operation because it is proportional to power demanded by the driver. This power P is the work W done by the vehicle over time, which is equal to the total force, Fₜₒₜₐₗ, acting on the vehicle multiplied by the distance traveled d:

$$P = \frac{W}{t} = {F}_{total} \cdot \frac{d}{t} . \qquad ( 1 )$$

The forces acting on the vehicle in the longitudinal direction consist of (a) tractive force, Fₓ; (b) drawbar force, Rₕₓ; (c) aerodynamic force, D_{A}; (d) rolling resistance force, Rₓ; and (e) the component of vehicle weight in this direction. The total force, Fₜₒₜₐₗ, is equal to the inertial force:

M·α=Fₜₒₜₐₗ=Fₓ+Rₕₓ−D_{A}−Rₓ−M·g·sin θ, (2)

where M is the vehicle mass, θ is the angle of the vehicle from horizontal, a is the vehicle acceleration in the longitudinal direction, and g is the gravitational constant. Substituting (2) in (1), the result is:

$$P = M \cdot α \cdot \frac{d}{t} = M \cdot ( α \cdot v ) , \qquad ( 3 )$$

where v is vehicle speed. Consequently, the power demanded by the driver is proportional to the product of the vehicle speed, v, and acceleration, α. This product is defined as the coefficient of power demand.

Driving cycles with lower average speed tend to have higher fuel consumption per meter, which can be associated with frequent transient engine operation. Three sets of driving cycles were used to investigate further the impact of the coefficient of power demand on fuel consumption—the Highway Fuel Economy Test (HWFET), the Japan 10-15, and the Federal Test Procedures (FTP) cycles. HWFET exhibits the lowest fuel consumption as it represents highway driving conditions and, thus, steady-state engine operation at high average vehicle speed. The Japan 10-15 and FTP driving cycles exhibit the highest fuel consumption per meter, deemed characteristic of their low average speeds.

In this context, the impact of the coefficient of power demand on fuel consumption was normalized and compared to the normalized fuel consumption rate over a given driving cycle. The normalization in both cases was with respect to maximum values. There appears to be a monotonic correlation between the coefficient of power demand and fuel consumption. To further investigate this relationship, the parts of a combined driving cycle that correspond to a high fuel consumption rate were identified. High fuel consumption rate is defined to be the values of the fuel consumption rate that are equal to or greater than the high fuel point, specified as two standard deviations above the mean fuel consumption rate. These high fuel consumption points were then mapped onto a graph of the driving cycle where they occurred. Then, the values of the coefficient of power demand were also plotted along the driving cycle. The graphs indicate that both the coefficient of power demand and the high fuel consumption rate provide the same information; thus, the coefficient of power demand constitutes a suitable indicator for aspects of a driving cycle that have a strong influence on fuel consumption.

Although these two driving factors (the stop factor and coefficient of power demand) can effectively model aspects of fuel consumption, the stop factor is a commuting characteristic rather than a driving one. As such, the stop factor is not easily altered by changing driving behavior but is instead more easily modified by changing the route. Consequently, for an optimization problem formulation, the goal of example algorithms for profile generation is to optimize a driving cycle with respect to the coefficient of power demand.

The product Autonomie was used to develop a framework to optimize a driving style with respect to the coefficient of power demand. Autonomie is a Matlab/Simulink simulation package for powertrain and vehicle model development, which was developed by Argonne National Laboratory. With a variety of existing forward-looking powertrain and vehicle models, Autonomie can support the evaluation of new technologies for improving fuel economy through virtual design and analysis in a math-based simulation environment. A vehicle model from Autonomie's database representing a midsize passenger vehicle was used in this example.

To construct an explicit relation between fuel consumption and the coefficient of power demand, and to formulate the optimization problem analytically to significantly reduce computation time, a set of polynomial metamodels were constructed. These models can reflect the responses in fuel consumption produced by changes in the coefficient of power demand. A metamodel is a “model of a model” that is used to approximate a usually expensive analysis or simulation process. Metamodeling refers to the techniques and procedures of constructing such a model. In this optimization framework, a set of polynomial metamodels was used to express the objective function in the problem formulation analytically. Fuel economy was evaluated though simulation in Autonomie over a grid of values for vehicle speed and acceleration in a particular driving cycle. Then, multivariate polynomial functions were fit to the data using the least squares method. The least squares method is a fundamental approach for parameter estimation. If the model treats the parameters linearly, then the least squares estimate can be calculated analytically. It was assumed that the model to be identified was in the form:

ŷ=φ₁(i)·w₁+φ₂(i)·w₂+ . . . +φₙ(i)·wₙ, (4)

where i=1, 2, . . . , n; nε [symbol] indexes the number of simulation data points; ŷ is the output of the model; w₁, w₂, . . . , wₙ are the parameters of the model to be determined; and φ₁, φ₂, . . . , φₙ are known functions that may depend on other known variables. The model in (4) can be written in the vector form as follows:

ŷ=φ^{T}(i)·w. (5)

The simulation data points derived from Autonomie correspond to pairs of the measured and regression variables {(y(i),φ^{T}(i), i=1, 2, . . . , n, nε [symbol] }. The problem is formulated so as to minimize the following least squares cost function with respect to the parameters of the model w₁, w₂, . . . , wₙ:

$$R ( w , n ) = \frac{1}{2} {\sum }_{i = 1}^{n} {[ y ( i ) - {ϕ}^{T} ( i ) \cdot w ]}^{2} . \qquad ( 6 )$$

The measured variable y is linear in parameters and the cost function is quadratic. Consequently, the problem permits an analytic solution. The vector of the model parameters w₁, w₂, . . . , wₙ that makes the error equal to zero was derived. For the optimization problem formulation, a polynomial metamodel of fuel consumption with respect to coefficient of power demand was derived that would be the objective function. A quadratic function of the form

$$f ( v , α ) = {w}_{1} \cdot {v}^{2} + {w}_{2} \cdot {α}^{2} + {w}_{3} \cdot {v}^{2} \cdot α + {w}_{4} \cdot v \cdot {α}^{2} + {w}_{5} \cdot v \cdot α + {w}_{6} \cdot v + {w}_{7} \cdot α + {w}_{8} \qquad ( 7 )$$

provides an appropriate fitting to the discrete simulation data points of fuel consumption, ƒ(v,α), with respect to vehicle speed, v, and acceleration, α. A higher order polynomial metamodel was also investigated, but this appeared to “overfit” the data. Likewise, a lower order polynomial provided a less accurate estimate of fuel consumption.

Different sets of discrete simulation data points consisting of a grid of vehicle speed and acceleration for three sets of driving cycles (Japan 10-15, combined FTP and HWFET, and FTP) were derived by running the vehicle model in Autonomie. These sets were used in (6) to compute the polynomial fitting coefficients, w. To assess the polynomial fitting with the discrete simulation data points, the following equation was used to evaluate the norm of residuals, which yields an indication of satisfactory curve fitting:

$$r = {( {\sum }_{t = 1}^{n} {[ {f}_{f . c .} ( t ) - f ( v ( t ) , α ( t ) ) ]}^{2} )}^{1 / 2} , \qquad ( 8 )$$

where ƒ_{f.c.}(t) is fuel consumption over time derived from Autonomie, ƒ(v(t), α(t)) is fuel consumption over time estimated by the polynomial metamodel, and n is the time horizon of the driving cycle. Table I lists the values of the polynomial coefficients of the metamodel of each driving cycle and the norm of residuals. The values of the norm of residuals demonstrate that the curve fits the data well.

TABLE I
Polynomial Coefficients of Fuel Consumption
Metamodels for Different Driving Cycles

| | | COMBINED FTP | |
|---|---|---|---|
| | JAPAN 10-15 | AND HWFET | FTP |
| w₁ | 0.208 × 10⁻⁶ | 0.442 × 10⁻⁶ | 0.222 × 10⁻⁶ |
| w₂ | 40.899 × 10⁻⁶ | −5.670 × 10⁻⁶ | 4.332 × 10⁻⁶ |
| w₃ | −0.532 × 10⁻⁶ | 1.166 × 10⁻⁶ | 1.250 × 10⁻⁶ |
| w₄ | 45.419 × 10⁻⁶ | 39.269 × 10⁻⁶ | 36.217 × 10⁻⁶ |
| w₅ | 86.518 × 10⁻⁶ | 58.284 × 10⁻⁶ | 57.877 × 10⁻⁶ |
| w₆ | 23.923 × 10⁻⁶ | 19.279 × 10⁻⁶ | 24.245 × 10⁻⁶ |
| w₇ | 26.602 × 10⁻⁶ | 82.426 × 10⁻⁶ | 77.482 × 10⁻⁶ |
| w₈ | 160.640 × 10⁻⁶ | 185.360 × 10⁻⁶ | 171.200 × 10⁻⁶ |
| r | 0.004 | 0.014 | 0.015 |

The optimization framework posed here determines the optimal values of the coefficient of power demand for improving fuel economy. Consequently, the objective of the optimization problem is to minimize fuel consumption in (7) with respect to vehicle acceleration, as the vehicle speed is a dependent variable of the former (i.e., a new acceleration profile will yield a new vehicle speed profile). Deceleration is not generally a major concern because the fuel cutoff controller in modern vehicles can successfully handle rapid deceleration. Although the act of braking consumes kinetic energy that might later be used to reduce fuel consumption during a subsequent acceleration, braking can be considered as part of the traffic rather than a controllable driving characteristic. The rate of deceleration has limited impact on fuel economy, as the fuel is shut off quickly when braking is applied.

Although a new acceleration profile will yield a new vehicle speed profile, the original driving cycle should be preserved (e.g., stop signs, traffic lights). To avoid a trivial solution (i.e., zero acceleration), a constraint was imposed on the difference between the resulting and the original vehicle speed profile. More specifically, the optimal acceleration profile was constrained to yield a new vehicle speed profile that was no more than 5 kph less than the original one. Alternatively, another constraint could be used, e.g., 10 kph less, 3 kph less, etc. In any case, a hard constraint could significantly reduce the feasible domain of the optimal solution. To overcome this limitation, the constraint was formulated as the norm of the difference between the original and the new speed profiles. This norm should be less than or equal to another norm, which is formulated as the difference between the original speed profile and a speed profile that is x kph less than the original. The inherent modularity of the proposed constraint circumvents the hard limit of the derived speed profile to be no more than x kph less than the original one. However, it preserves the average discrepancy to be within these limits, and thus, it enables the feasible space of the acceleration profile to include solutions resulting in smooth shaping of the speed profile. The value of x kph can be altered as desired, thus providing the flexibility to have a more or less conservatively optimized driving cycle.

Consequently, the following non-linearly-constrained optimization problem was formulated (using “5 kph less” as an example constraint):

$${min}_{α} f ( v ( t ) , α ( t ) ) \\ s . t . ‖ v ( t ) - {v}^{*} ( t ) ‖ \leq ‖ v ( t ) - {v}_{5 kph} ( t ) ‖ , \qquad ( 9 )$$

where v(t) is the original vehicle speed of the driving cycle; v*(t) is the optimal speed profile corresponding to the optimal acceleration profile, α*(t); and v_{5 kph}(t) is the vehicle speed profile, which is 5 kph less than the original one.

The optimization problem formulation in (9) may yield conservative acceleration profiles with a potentially much longer travel duration. To provide more flexibility to the user, a second optimization problem was formulated with a constraint focusing on the travel duration:

$${min}_{α} f ( v ( t ) , α ( t ) ) \\ s . t . {t}_{optimized} \leq {t}_{original} \cdot ( 1 + q ) , \qquad ( 10 )$$

where t_{optimized} is the travel duration of the optimized driving cycle, t_{original} is the travel duration of the original driving cycle, and q is the desired percentage that the travel duration of the optimized cycle can exceed the original one.

The optimization problems in (9) and (10) were solved iteratively until convergence, using the Matlab function ƒmincon, based on sequential quadratic programming (SQP). SQP proceeds by computing an approximate solution of a sequence of quadratic programming subproblems in which a quadratic model of the objective function is minimized subject to the linearized constraints.

The acceleration profile, α(t), yields a vehicle speed profile, v(t). This speed profile was used to constrain the optimization problem iteratively until convergence to the optimal acceleration, α*(t), and speed, v*(t), was achieved. In this iterative process, the construction of the vehicle speed profile needs to preserve the total distance that the vehicle travels as well as the instances where the vehicle must stop. In other words, the desired route of the driver and the traffic control features must be preserved. Integrating the acceleration may not be enough to accurately obtain a new driving cycle because some route-related information is not described by the acceleration profile (e.g., when the vehicle is stopped and the duration for which the vehicle is stopped). This information is available, however, from the original drive cycle. Therefore, to preserve the total distance, the distance, Δs, that the vehicle covers within a time interval Δt should remain constant. The total distance that the vehicle travels is given by:

$$\begin{matrix}S = {\sum }_{t = 1}^{n + 1} Δ {s}_{i} \\ = {\sum }_{k = 0}^{n} ( {s}_{k + 1} - {s}_{k} ) = \\ = {\sum }_{k = 0}^{n} ( {v}_{k} \cdot ( {t}_{k + 1} - {t}_{k} ) + \frac{1}{2} \cdot ( {v}_{k + 1} - {v}_{k} ) \cdot ( {t}_{k + 1} - {t}_{k} ) ) .\end{matrix} \qquad ( 11 )$$

The time interval, Δt=tₖ₊₁−tₖ, may not be constant, however, and depends on the acceleration, αₖ, at time k. The time interval, Δt, is computed by (11) using each interval of distance, Δs, of the original driving cycle. For each Δs covered, both initial velocity and initial time are known, so the time Δt to travel the distance Δs is computed by (11). The optimal speed profile, v*(t), is derived at each time through the following equation:

$${v}_{k + 1}^{*} = {\sum }_{k = 0}^{n} ( {v}_{k}^{*} + {a}_{k}^{*} \cdot ( {t}_{k + 1} - {t}_{k} ) ) . \qquad ( 12 )$$

This process was repeated over all of the distance intervals, and the new velocity and time vectors were constructed.

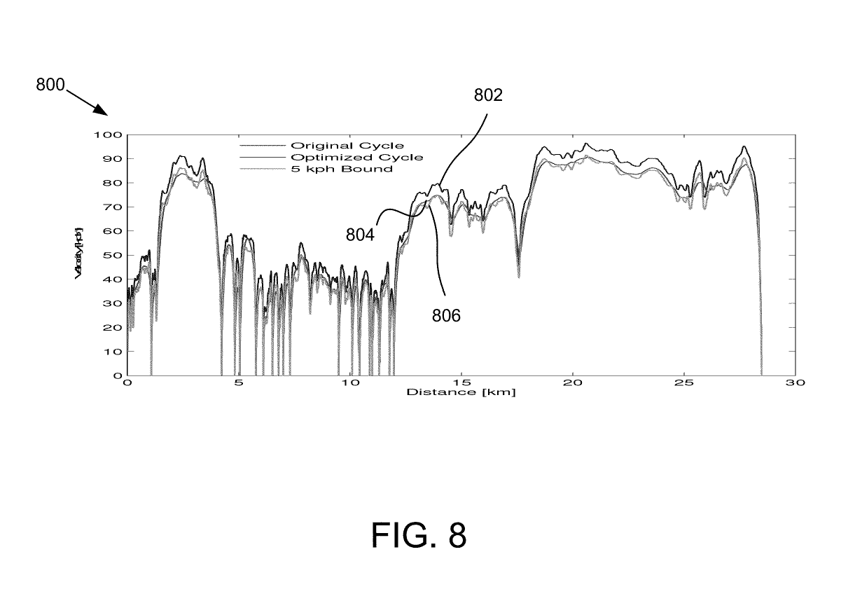

The optimization framework described above was applied to three sets of driving cycles: Japan 10-15, combined FTP and HWFET, and FTP. In the case of the combined FTP and HWFET driving cycles, a new optimized driving cycle was obtained. The optimal driving cycle is slightly longer than the original (observed) one since the new acceleration profile aims to smooth out the vehicle speed. FIG. 8 is a plot 800 of velocity vs. distance that includes original speed profile 802, optimized speed profile 804, and a 5 kph speed difference bound 806 from original speed profile 802. Although optimized speed profile 804 in some instances falls slightly below bound 806, which is 5 kph less than original speed profile 802, the optimal solution is bounded by the active constraint in (9). For the optimized profile, the total distance traveled and intermediate stops have been preserved (i.e., the route has been preserved).

Smoothing out the speed profile to reduce transient engine operation results in significant fuel economy enhancement. A more conservative driving style that delays destination arrival time has a major impact on fuel consumption. In this particular case, a 15.9% improvement was observed. Similar qualitative results were observed for the Japan 10-15 and FTP driving cycles. However, delaying travel duration by this amount might not be acceptable to all drivers. Thus, using the optimization problem formulation in (10), one can customize the acceptable additional duration and limit the feasible optimal solution space. Table II summarizes the improvement in fuel consumption for the three driving cycles when the optimization problem in (9) is used. Table III summarizes the improvement in fuel consumption for the optimization problem formulation in (10), in which the additional duration is constrained to within y % of the original travel duration. The value of y depends on implementation. In the results shown in Table III, for example, y is 5.

TABLE II
Summary of Optimization Results

| DRIVING | ADDITIONAL TRAVEL | FUEL CONSUMPTION |
|---|---|---|
| CYCLE | TIME (%) | IMPROVEMENT (%) |
| JAPAN 10-15 | 28.0 | 22.3 |
| COMBINED FTP | 9.8 | 15.9 |
| AND HWFET | | |
| FTP | 14.1 | 23.2 |

TABLE III
Summary of Optimization Results with Time Constraint

| DRIVING | ADDITIONAL TRAVEL | FUEL CONSUMPTION |
|---|---|---|
| CYCLE | TIME (%) | IMPROVEMENT (%) |
| JAPAN 10-15 | 4.6 | 9.6 |
| COMBINED FTP | 5.0 | 4.6 |
| AND HWFET | | |
| FTP | 5.0 | 4.5 |

The optimization problem can also be modified by trying to maintain the same average speed for both the original and the resulting driving cycles. However, the original driving cycle is assumed to be limited by the speed limit(s), which should not be exceeded by the resulting driving cycle. In this case, the problem would be overconstrained, with the result that no feasible solution would be derived, unless the constraint initially imposed to preserve the distance (i.e., the route) were relaxed, and the optimized driving cycle may imply a change in the route. In contrast, in approaches described herein, the impact of the coefficient of power demand on fuel economy was investigated while preserving the original route (e.g., traffic lights, stop signs).

### Example Use Cases

In an example use case, a user (for example, the driver) gathers vehicle data after driving a route using a typical driving style. For example, a USB drive can be plugged into the onboard diagnostics (OBD) of the vehicle after the driver has driven the vehicle the length of the route. The engine records two signals that can be retrieved: (a) the vehicle speed profile (speed for different distances or speed for different times), and (b) the fuel consumption rate. A user loads these two signals to an application running the optimization framework presented above. A user can select criteria for optimizing driving style in the optimization problem. For example, the user may specify that an optimized driving style should vary no more than a certain number of kilometers per hour from the original speed profile [optimization problem (9)] and/or specify that the duration should not exceed a certain percentage of the original duration [optimization problem (10)]. Vehicle data from multiple drives along the route can be averaged, if desired, for the observed profile.

After running the application, the new optimized vehicle speed profile can be used by the driver to learn how to adapt his/her driving style to the optimized profile. The optimal acceleration profile is integrated over the time intervals and then multiplied by a time-varying coefficient c₁(t):

c₁(k)·(a*ₖ₊₁−a*ₖ)·(tₖ₊₁−tₖ)=1,k=1,2 . . . ,n,nε [symbol] (13)

where n is the time horizon of the driver's route. The coefficient c₁(t) makes this product at each time interval Δt always equal to 1. This can be represented as the area of a square as illustrated by first shape 306 of FIG. 3B. Another time-varying coefficient, c₂(t), can be defined that multiplies the current acceleration values created as the driver drives the vehicle:

$${c}_{2} ( k ) \cdot ( {a}_{k + 1} - {a}_{k} ) \cdot ( {t}_{k + 1} - {t}_{k} ) = \frac{1}{{c}_{1} ( k )} . \qquad ( 14 )$$

The coefficient c₂(t) makes the product in the left-hand side of (14) less than 1 at each time interval, Δt, as long as the driver's acceleration, α(t), at each time interval, Δt, is less than the optimal acceleration profile, α*(t). This product represents the area of another square shown by second shape 308 of FIG. 3B. The coefficient c₂(t) is computed periodically from (14) based on the driver's current acceleration, and the corresponding shape is plotted against the area of the optimal acceleration profile. In this example, the area of first shape 306 is constant and represents the current preferred acceleration for a location. Second shape 308 represents the driver's current actual acceleration and changes over time with respect to the accelerator pedal position. As the driver drives the vehicle, the current acceleration (second shape 308) should be less than or just overlap the optimal acceleration profile (first shape 306) at each time. After repeating the same route by following these visual instructions, the driver can eventually learn the optimized driving style and the most efficient position of the accelerator pedal to achieve a certain amount of benefit in fuel economy.

### Example Mobile Devices

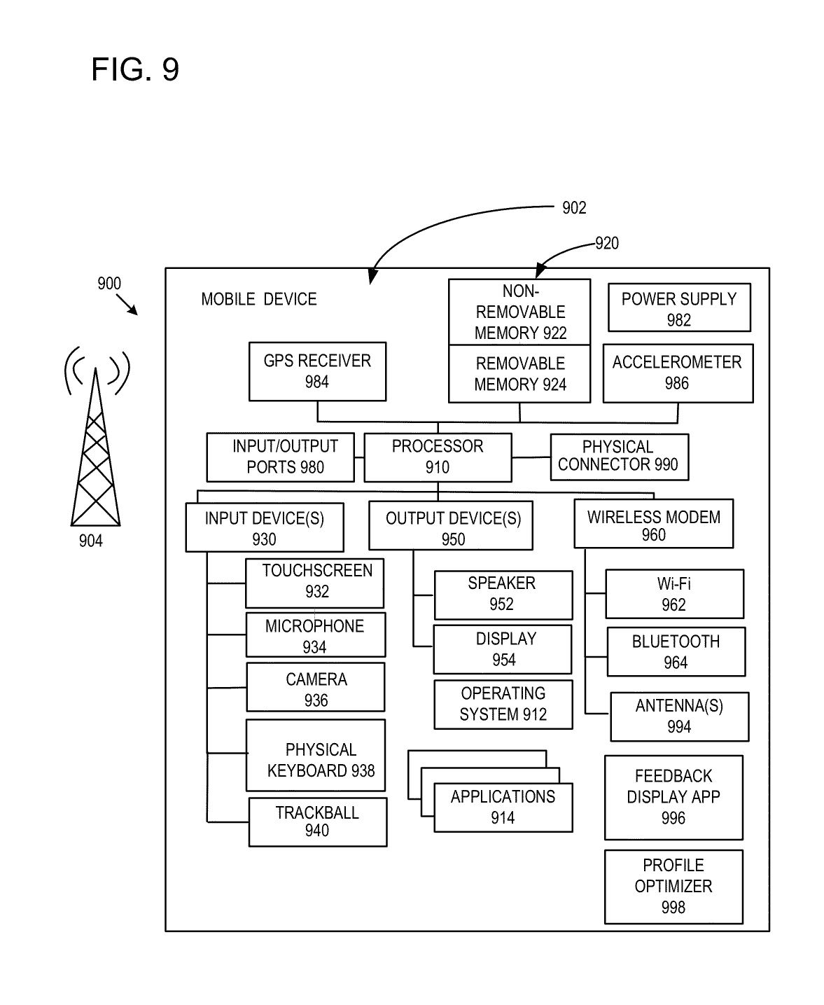

FIG. 9 is a system diagram depicting an example mobile device 900 including a variety of optional hardware and software components, shown generally at 902. Any components 902 in the mobile device can communicate with any other component, although not all connections are shown, for ease of illustration. Mobile device 900 can be any of a variety of computing devices (e.g., cell phone, smartphone, handheld computer, tablet, Personal Digital Assistant (PDA), etc.) and can allow wireless two-way communications with one or more mobile communications networks 904, such as a cellular or satellite network.

The illustrated mobile device 900 can include a controller or processor 910 (e.g., signal processor, microprocessor, ASIC, or other control and processing logic circuitry) for performing such tasks as signal coding, data processing, input/output processing, power control, and/or other functions. An operating system 912 can control the allocation and usage of the components 902 and support for one or more application programs 914. The application programs can include common mobile computing applications (e.g., email applications, calendars, contact managers, web browsers, messaging applications), or any other computing application.

The illustrated mobile device 900 can include memory 920. Memory 920 can include non-removable memory 922 and/or removable memory 924. The non-removable memory 922 can include RAM, ROM, flash memory, a hard disk, or other well-known memory storage technologies. The removable memory 924 can include flash memory or a Subscriber Identity Module (SIM) card, which is well known in GSM communication systems, or other well-known memory storage technologies, such as “smart cards.” The memory 920 can be used for storing data and/or code for running the operating system 912 and the applications 914. Example data can include web pages, text, images, sound files, video data, or other data sets to be sent to and/or received from one or more network servers or other devices via one or more wired or wireless networks. The memory 920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 900 can support one or more input devices 930, such as a touchscreen 932, microphone 934, camera 936, physical keyboard 938 and/or trackball 940 and one or more output devices 950, such as a speaker 952 and a display 954. Other possible output devices (not shown) can include piezoelectric or other haptic output devices. The input devices 930 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 912 or applications 914 can comprise speech-recognition software as part of a voice user interface that allows a user to operate the device 900 via voice commands.

A wireless modem 960 can be coupled to an antenna 994 and can support two-way communications between the processor 910 and external devices, as is well understood in the art. The modem 960 is shown generically and can include a cellular modem for communicating with the mobile communication network 904 and/or other radio-based modems (e.g., Bluetooth or Wi-Fi). The wireless modem 960 is typically configured for communication with one or more cellular networks, such as a GSM network for data and voice communications within a single cellular network, between cellular networks, or between the mobile device and a public switched telephone network (PSTN).

The mobile device can further include at least one input/output port 980, a power supply 982, a satellite navigation system receiver 984, such as a Global Positioning System (GPS) receiver, an accelerometer 986, and/or a physical connector 990, which can be a USB port, IEEE 1394 (FireWire) port, and/or RS-232 port. When the mobile device 900 operates as a real-time feedback system, the GPS receiver can provide location data and vehicle data. Or, vehicle data such as acceleration data and/or speed data can be provided from an onboard computer or other system through the USB port or another port.

Mobile device 900 includes a feedback display app 996 and a profile optimizer 998, which can be implemented as part of applications 914. Feedback display app 996 can perform the methods described with reference to FIGS. 1, 4 and 5. Feedback display app 996 can render for display the graphic comparing current and preferred vehicle acceleration, as discussed above, or otherwise provide an indication of correspondence between current and preferred acceleration values. Instead of being located on mobile device 900, profile optimizer 998 can be located on a separate computing device.

The illustrated components 902 are not required or all-inclusive, as any components can deleted and other components can be added.

### Example Computing Environments

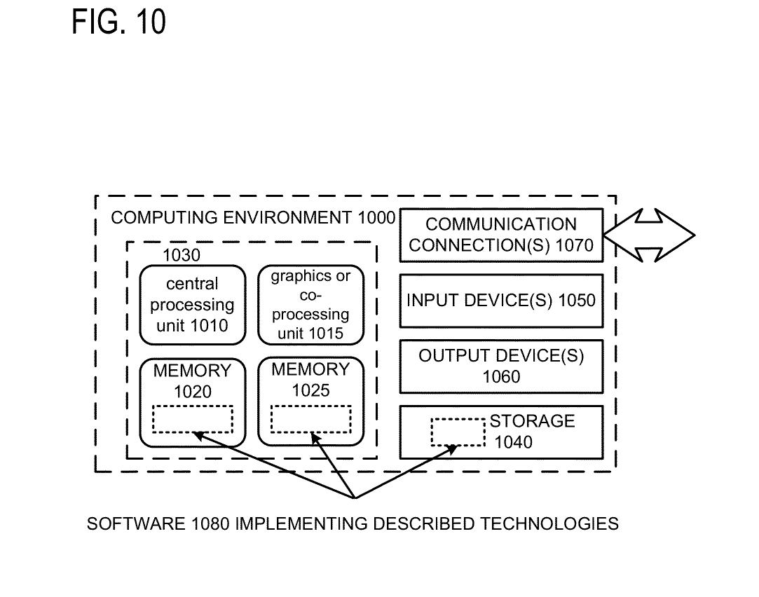

FIG. 10 depicts a generalized example of a suitable computing environment 1000 in which the described innovations may be implemented. The computing environment 1000 is not intended to suggest any limitation as to scope of use or functionality, as the innovations may be implemented in diverse general-purpose or special-purpose computing systems. For example, the computing environment 1000 can be any of a variety of computing devices (e.g., desktop computer, laptop computer, server computer, tablet computer, media player, gaming system, mobile device, etc.)

With reference to FIG. 10, the computing environment 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s). For example, profile optimizer 606 shown in FIG. 6 can be stored.

A computing system may have additional features. For example, the computing environment 1000 includes storage 1040, one or more input devices 1050, one or more output devices 1060, and one or more communication connections 1070. An interconnection mechanism (not shown) such as a bus, controller, or network interconnects the components of the computing environment 1000. Typically, operating system software (not shown) provides an operating environment for other software executing in the computing environment 1000, and coordinates activities of the components of the computing environment 1000.

The tangible storage 1040 may be removable or non-removable, and includes magnetic disks, magnetic tapes or cassettes, CD-ROMs, DVDs, or any other medium which can be used to store information in a non-transitory way and which can be accessed within the computing environment 1000. The storage 1040 stores instructions for the software 1080 implementing one or more innovations described herein. For example, storage 1040 can include software for profile optimizer 606 shown in FIG. 6. Modules contain computer-executable instructions.

The input device(s) 1050 may be a touch input device such as a keyboard, mouse, pen, or trackball, a voice input device, a scanning device, or another device that provides input to the computing environment 1000. The output device(s) 1060 may be a display, printer, speaker, CD-writer, or another device that provides output from the computing environment 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media, which excludes propagated signals). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionally described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

We claim:

1. One or more computer-readable memory or storage devices storing instructions that, when executed by a computing device having a processor, perform a method for increasing vehicle fuel efficiency, the method comprising:
receiving vehicle speed or acceleration data for a location on a route;
deriving a current acceleration value for the location using the received vehicle speed or acceleration data;
determining a preferred acceleration value for the location based on a preferred speed or acceleration profile that is specific to the route; and
providing an indication of a correspondence between the preferred acceleration value for the location and the current acceleration value for the location.

2. The computer-readable memory or storage devices of claim 1, wherein providing the indication comprises displaying a graphic.

3. The computer-readable memory or storage devices of claim 2, wherein the graphic illustrates a comparison between a representation of the preferred acceleration value and a representation of the current acceleration value.

4. The computer-readable memory or storage devices of claim 2, wherein the graphic comprises a first shape representing the preferred acceleration value and a second shape representing the current acceleration value, and wherein when the size of the first and second shapes are equal, the current acceleration value is equal to the preferred acceleration value.

5. The computer-readable memory or storage devices of claim 1, wherein the indication is a tone, and wherein pitch of the tone is varied depending on the correspondence between the current acceleration value and the preferred acceleration value.

6. The computer-readable memory or storage devices of claim 1, wherein the preferred speed or acceleration profile is based at least in part on an observed speed or acceleration profile, and wherein the preferred speed or acceleration profile provides greater fuel efficiency over the route compared to the observed speed or acceleration profile.

7. The computer-readable memory or storage devices of claim 6, wherein the preferred speed or acceleration profile is based on smoothing of the observed speed or acceleration profile.

8. The computer-readable memory or storage devices of claim 6, wherein the preferred speed or acceleration profile is based at least in part on one or more constraints defined by a user.

9. The computer-readable memory or storage devices of claim 8, wherein the one or more constraints comprise at least one of (a) an acceptable difference in speed compared to the observed speed or acceleration profile and (b) an acceptable additional route completion time compared to duration of the observed speed or acceleration profile.

10. The computer-readable memory or storage devices of claim 1, wherein the preferred speed or acceleration profile includes speed or acceleration values for a plurality of locations on the route.

11. The computer-readable memory or storage devices of claim 1, wherein the method further comprises repeating the receiving, deriving, determining, and providing for a plurality of successive locations on the route.

12. A computer-implemented method for increasing vehicle fuel efficiency, the method comprising:
receiving an observed speed or acceleration profile that is specific to a route;
based at least in part on the observed speed or acceleration profile, determining a preferred speed or acceleration profile that is specific to the route, wherein the preferred speed or acceleration profile provides greater fuel efficiency over the route compared to the observed speed or acceleration profile; and
storing the preferred speed or acceleration profile for use in a real-time feedback system.

13. The method of claim 12, wherein the determining the preferred speed or acceleration profile includes smoothing the observed speed or acceleration profile.

14. The method of claim 12, wherein the preferred speed or acceleration profile is based at least in part on one or more constraints defined by a user.

15. The method of claim 14, wherein the one or more constraints comprise at least one of (a) an acceptable difference in speed compared to the observed speed or acceleration profile and (b) an acceptable additional route completion time compared to duration of the observed speed or acceleration profile

16. The method of claim 15, wherein the acceptable difference in speed is less than or equal to x miles or kilometers per hour, x being a number greater than zero, and wherein the acceptable additional route completion time is less than or equal to y percent, y being a number greater than zero.

17. A computer-implemented method for increasing vehicle fuel efficiency, the method comprising:
for each of a plurality of locations on a route:
receiving speed and location data for a vehicle at the location on the route;
determining a current vehicle speed based on the received speed data;
if the current vehicle speed is greater than a threshold, determining a preferred vehicle acceleration value for the location based on a preferred speed or acceleration profile for the route;
if the current vehicle speed is less than the threshold, determining an alternative preferred vehicle acceleration value;
calculating a current vehicle acceleration value for the location using the received speed and location data; and
displaying a graphic comparing the current vehicle acceleration value to either the preferred vehicle acceleration value or the alternative preferred vehicle acceleration value.

18. The method of claim 17, wherein the alternative preferred vehicle acceleration value is used when the vehicle is accelerating from a stop.

19. The method of claim 17, wherein the preferred speed or acceleration profile is based at least in part on an observed speed or acceleration profile, wherein the preferred speed or acceleration profile provides greater fuel efficiency over the route compared to the observed speed or acceleration profile, and wherein the preferred speed or acceleration profile is specific to both the route and the vehicle.

20. The method of claim 19, wherein the preferred speed or acceleration profile is determined by smoothing the observed speed or acceleration profile subject to one or more constraints defined by a user.
